(19) United States
(12) Patent Application Publication
(10) Pub. No.: US 2023/0358891 A1
(43) Pub. Date: Nov. 9, 2023

(54) A TIME-OF-FLIGHT SENSOR SYSTEM

(71) Applicant: CAMBRIDGE MECHATRONICS LIMITED, Cambridge, Cambridgeshire (GB)

(72) Inventors: Joshua Carr, Cambridge (GB); David Richards, Cambridge (GB)

(21) Appl. No.: 17/925,749

(22) PCT Filed: May 19, 2021
(86) PCT No.: PCT/GB2021/000056

§ 371 Date: Nov. 16, 2022

(30) Foreign Application Priority Data
May 19, 2020 (GB) 2007388.8
May 19, 2020 (GB) 2007390.4

(51) Int. Cl. G01S 17/894; G01S 7/481

(52) U.S. Cl. CPC G01S 17/894; G01S 7/4817; G01S 7/4814; G01S 7/4816

(57) ABSTRACT

A time-of-flight sensor system 10 comprising: an illumination source 11 for illuminating a subject 19 to which a time-of-flight is to be measured; an optical system configured to, using an at least one actuator, transition the illumination source 11 between providing spot illumination and flood illumination; and a sensor 12 comprising a sensor surface. The sensor surface is configured to sense light scattered by the subject 19 from the illumination source 12 and to provide data dependent on sensed light. The spot illumination has a spatially non-uniform intensity over the sensor surface, and the optical system is configured to move the spot illumination across at least part of the sensor surface to generate an output frame, wherein the at least one actuator comprises at least one shape memory alloy (SMA) component.

### FIELD

The present invention relates to a time-of-flight sensor system, a method of sensing light scattered from a subject for a time-of-flight sensor system, an actuation apparatus for a time-of-flight sensor system, and a method for an actuation apparatus in a time-of-flight sensor system.

### Background

A time-of-flight sensor system uses time-of-flight to resolve distance between the sensor and the subject for each point of an image. The time-of-flight is measured, for example, by measuring the round trip time of an artificial light signal or pulse to and then reflected from the subject in a direct time-of-flight system. Thus, the distance to the subject is half the product of speed of light (3×10⁸ ms⁻¹) and measured time of flight to and from the subject. Alternatively, in an indirect time-of-flight system, the time-of flight can be based on measuring phase difference between an emitted signal and a received signal.

Invisible light wavelengths may be used for time-of-flight camera systems to avoid disturbing a subject that is being imaged (which may also be captured with a visible light camera). The near infrared (NIR) band (wavelengths 750 nm to 1.4 μm) is typically chosen due to the availability of small (portable) lasers with good resolving potential.

A time-of-flight three dimensional (3D) sensor can use light provided by artificial light that is in the form of flood illumination or spot illumination. Flood illumination is where defocused, spatially uniform light is provided over an area of interest. Spot illumination is where light is focused into an array of spots over the area of interest, hence a spatially non-uniform light is provided. Flood illumination gives a high resolution depth map, but with a limited distal range due to the limited intensity of the flood illumination. Spot illumination gives an increased distal range compared to flood illumination, but this reduces the resolution, to the number of pixels illuminated by light scattered from the flood illumination.

A time-of-flight 3D sensor may switch between the modes of flood illumination and spot illumination. In such an arrangement, a focusing optical element in the form of a lens is moved by an actuator along an optical axis to defocus the spot illumination to create a flood illumination and then to a focus position to create the spot illumination.

Such known arrangements may operate using spot illumination or flood illumination depending on a desired application. However, given the existing drawbacks of flood illumination and spot illumination, namely limited range and limited resolution respectively, there is room for improvement on existing systems and particularly the applicability of such systems in a wide range of applications.

Attempts have been made to improve spot illumination techniques to compensate for the loss of resolution due to use focussed light. For example, a scanning method has previously been provided by the applicant where an actuator engages the light source to move the spot illumination across the area of interest. An actuator then engages with a light source to move the spots relative to the scene. In this way the method scans the scene to rebuild a full resolution image. This is shown in FIG. 6.

Whilst this method provides advantages over traditional TOF systems, this type of scanning technique may encounter difficulties when implemented by legacy systems. For example, a single spot may span a number of pixels on the image sensor's detector surface. During the scanning process, the spot 80 is moved across the sensor surface to illuminate further pixels, thereby improving resolution—this is shown in FIG. 6 by the dashed arrows. However, each frame contains many pixels 81 which are not illuminated and therefore contain no depth information. This could be as much as 90% of the pixels, meaning there could be, for example, as many as ˜270,000 pixels read each 0.3 megapixel frame which contain no useful information. However, they must still be read out. Similarly, as the spot illumination is scanned across the sensor surface, some pixels may be missed—i.e. the scan positions may not cover all pixels—meaning that certain pixels may never contribute useful information across all scans. This is shown in FIG. 6.

### SUMMARY

The inventors of the present invention have appreciated that it is possible to provide a versatile time-of-flight sensor system capable of providing optimum 3D sensing for varying conditions. In particular, the inventors have appreciated that it is possible to provide a 3D imaging system capable of providing optimal performance in all environments by trading off range, resolution, and frame rate where necessary.

The invention is defined by the independent claims to which reference should now be made. Optional features are set forth in the dependent claims.

According to an aspect of the present invention, there is provided a time-of-flight sensor system comprising: an illumination source for illuminating a subject to which a time-of-flight is to be measured; an optical system configured to transition the illumination source between providing spot illumination and flood illumination; and a sensor comprising a sensor surface, the sensor being configured to sense light scattered by the subject from the illumination source and to provide data dependent on sensed light, wherein the spot illumination has a spatially non-uniform intensity over the sensor surface, and the optical system is configured to, using an at least one actuator, move the spot illumination across at least part of the sensor surface to generate an output frame, wherein the at least one actuator comprises at least one shape memory alloy (SMA) component.

The time-of-flight sensor system of the present invention is capable of providing both spot illumination and flood illumination. Significantly, while providing spot illumination, the sensor system is also capable of moving the spot illumination across at least part of the sensor surface to generate an image output. In doing so, the sensor system of the present invention is capable of providing optimum 3D imaging depending on the desired application. For example, typically, flood illumination provides relatively high resolution compared to spot illumination, but is effective at relatively short range compared to spot illumination. In contrast, spot illumination is capable of functioning effectively at larger distances than flood illumination, but typically provides lower resolution. Furthermore, moving the spot illumination across at least part of the sensor surface provides a higher resolution than not moving the spot illumination. Thus, depending on a given circumstance, an optimum configuration or mode of operation may be used for the time-of-flight sensor system.

The provision of both spot illumination and flood illumination in a single time-of-flight sensor system may be referred to as a dual-profile time-of-flight sensor system. The moving of the spot illumination across at least part of the sensor surface to generate an output image (described in more detail below) may be referred to as dotscan sensing. The inventors of the present invention have appreciated that a single time-of-flight sensor system may combine the concepts of a dual-profile system with dotscan sensing, to provide a versatile time-of-flight sensor system.

The time-of-flight sensor system may be, or may be provided in, any compatible apparatus or device, including a smartphone, a mobile computing device, a laptop, a tablet computing device, a security system, a gaming system, an augmented reality system, an augmented reality device, a wearable device, a drone, an aircraft, a spacecraft, a vehicle, an autonomous vehicle, a robotic device, a consumer electronics device, a domotic device, and a home automation device.

The flood illumination and spot illumination may be provided or emitted by any suitable light source. For example, the light source may be a source of non-visible light or a source of near infrared light. The light source may comprise at least one laser, laser array (such as a vertical cavity surface emitting laser (VCSEL) array), or may comprise at least one light emitting diode (LED).

The optical system may be configured to move the spot illumination in a scanning pattern across at least part of the sensor surface. The scanning pattern may comprise moving the spot illumination along a first direction across at least part of the sensor surface. The scanning pattern may further comprise moving the spot illumination along a second direction across at least part of the sensor surface. The first direction may be perpendicular to the second direction, or angled to the second direction in a plane. That is, the first direction may be angled at a non-zero angle to the second direction. The scanning pattern may be a raster scanning pattern. The scanning pattern may be boustrophedonic. Increasing the number of (scanning) points in the scanning pattern may result in a more uniformly illuminated sensor surface or field of view, which may allow improved resolution across the whole sensor surface. However, the more points in the scanning pattern, the more frames which need to be captured and combined in order to generate the output frame. The more frames there are, the more time it takes to capture the frames for combining. Thus, the scanning pattern may be chosen to suit the application.

The same scanning pattern may be used in different cycles of the scanning pattern, or different scanning patterns may be used in different cycles of the scanning pattern. In other words, a cycle of the scanning pattern may comprise moving the spot illumination across at least part of the sensor surface in a plurality of discrete movements, or one or more continuous movements, or a combination of both. Subsequent cycles of the scanning pattern may then use the same cycle as previously used, or may use different cycles. For example, different cycles may allow scanning at different points in each of the cycles (e.g. different areas of interest), or the scanning the same points in different order (e.g. different scanning paths). The non-uniform illumination may move in discrete positions across at least part of the sensor surface, or may move continuously across at least part of the sensor surface. This is because time-of-flight measurement techniques rely only on illumination intensity over a period, and there is no need for the moving illumination to come to rest in order for the scene to be sampled.

The spatially non-uniform illumination (spot illumination) may be moved based on both the subject to which a time-of-flight is to be measured and the intensity or signal-to-noise ratio of the received/sensed/detected reflected light. For example, if very little light is detected by the sensor, the system may determine that the subject is too far away and so may move the illumination to a new position. Similarly, if the intensity of the reflected light is very high, then sufficient information about the field of view may be gathered relatively quickly, such that the illumination can be moved to a new position (to capture data about another region) relatively quickly, whereas if the intensity of the reflected light is low, the illumination may need to be held in position for longer to allow enough data to be gathered to produce a reliable 3D image. Thus, in some embodiments, the spatially non-uniform illumination may be moved in response to intensity and/or signal-to-noise ration of sensed reflected light.

The optical system may move the spot illumination in the scanning pattern using the at least one actuator. The at least one actuator may be any suitable actuation mechanism for incorporation into the sensor system. For example, the at least one actuator may comprise the shape memory alloy (SMA) actuator, which may comprise at least one SMA component, such as an SMA actuator wire. The SMA actuator wire may be coupled to the or each element of the apparatus which may be moved in order to move the emitted non-uniform illumination across at least part of the sensor surface. Additionally or alternatively, the at least one actuator may comprise a voice coil motor (VCM), an optical image stabilisation actuator, an auto-focus actuator, a 4 wires SMA actuator or 8 wires SMA actuator, a module tilt actuator, or an adaptive beam-steering mechanism for steering the non-uniform illumination (spot illumination). The at least one actuator may be arranged to move the emitted non-uniform illumination by moving any one of the following components which may be comprised in an apparatus present the time-of-flight sensor system: a lens, a prism, a mirror, a dot projector, and a light source. The at least one actuator may provide at least one degree of freedom to provide the scanning pattern, for example two degrees of freedom.

The optical system may be configured to focus and defocus the illumination source using the at least one actuator by moving, relative to a support structure, a moveable element between a respective first position and second position, or any position between the first and second positions. That is, the sensor system may comprise a support structure. By moving the moveable element, relative to the support structure, to the first position, the illumination source may be focused; by moving the moveable element to the second position, the illumination source may be defocused. The moveable element may comprise a lens element, a lens, a prism, a mirror, or a diffraction grating. The moveable element may be provided “in front of” the illumination source i.e. between the illumination source and the subject to which a time-of-flight is to be measured. The at least one actuator may provide at least one degree of freedom for focusing and defocusing the illumination source, for example by providing a degree of freedom to the moveable element along the movement axis.

The at least one actuator may be configured to move the moveable element between the first position and the second position, or between the second position and the first position, in less than 10 ms, optionally less than 5 ms, and optionally less than 3 ms. Such speeds are beneficial because the time taken for the moveable element to move between first and second positions may be the time between sub frame integration periods for the ToF sensor. Thus, the faster the time of movement of the moveable element between the first position and the second position, the less data collection time that is lost (where the data collection time includes time in which illumination is provided by the illumination source and can be sensed by the sensor).

The at least one actuator may comprise an SMA component connected between the moveable element and the support structure, the SMA component being configured to, on contraction, move the moveable element from the first position to the second position. The SMA component may be configured to, on contraction, move the moveable element from the first position to any position between the first position and the second position, e.g. the moveable element may move to and holds at any position between the first position and the second position. The SMA component may be caused to contract by heating, for example with an electrical current. When the SMA component is caused to contract, its connection to the moveable element and the support structure may be such that the moveable element is moved to the second position from the first position, or from the current position of the moveable element. That is, contraction of the SMA component may cause the moveable element to move to the second position from its current position. The at least one actuator may also comprise a second SMA component connected between the moveable element and the support structure, the second SMA component being configured to, on contraction, move the moveable element from the second position to the first position. The second SMA component may be configured to, on contraction, move the moveable element from the second position to any position between the second position and the first position, e.g. the moveable element may move to and holds at any position between the second position and the first position. The second SMA component may be caused to contract as above. When caused to contract, the connection of the second SMA component to the moveable element and the support structure may be such that the moveable element is caused to move to the second position. Alternatively, the moveable element may be moved or returned from the second position to the first position using an elastic element such as a spring.

The at least one actuator may comprise one or more flexures configured to retain the moveable element in the first position or in the second position when the SMA component is not energised. A flexure may be a flexible element being compliant in specific degrees of freedom. A flexure may be an elastic element such as a spring, such as a bi stable spring. By using flexures to retain the moveable element in the first or second position, this allows the heat to be removed from the SMA component when the moveable element is in the first or second position, thereby reducing the power consumption of the at least one actuator and the system as a whole. In one embodiment, the SMA component may be in connection with the elastic element such as the bi stable spring, rather than in connection with the moveable element, thereby providing a simpler drive system.

The moveable element may be configured to move along a movement axis and may be prevented from moving beyond the first position or the second position by support portions of the support structure. The support portions may be endstops or end portions. The support portions may be configured such that they prevent the movement of the moveable element from moving further along the movement axis than the first position and the second position. That is, the support portions may provide limits or boundaries on the movement on the moveable element. The support portions or endstops or end portions may enable the actuation apparatus to achieve the high speeds described above for moving the moveable element between the first and second positions.

The moveable element may be orientated at a non-zero angle to the orientation of the support portions such that when the moveable element moves towards the first position or the second position, a first portion of the moveable element contacts the support portion before a second portion of the moveable element, causing the moveable element to be tilted about a rotation axis. By doing so, the audible noise output produced by the impulse of the moveable element contacting the support portion is reduced.

The at least one actuator may be configured to tilt the moveable element about the rotation axis by use of an SMA component or an elastic element. The SMA component may be a separate SMA component to that of the at least one actuator used to move the moveable element between the first position and the second position. The rotation of the moveable element may be caused by the force applied by the SMA component continuing to apply force in a direction after the moveable element first contacts the support portion at the first portion of the moveable element. The rotation of the moveable element may continue until the second portion of the moveable element contacts the support portion, or until the moveable element is substantially parallel with the support portion. The moveable element may be substantially parallel with the support portion or portions when situated at the first position or the second position. The first and second portions of the moveable element may each comprise a contact surface for contacting the respective support portions, wherein the contact surface of the first portion is angled to the contact surface of the second portion.

The support portions may be coated with a grease or hysteric gel. This advantageously reduces the audible noise output caused when the moveable element contacts the support portions. The support portions may comprise contact portions at which the moveable element first contacts the support portions when moving to the first position of the second position, the contact portions being configured to reduce audible noise output produced when the moveable element contacts the contact portions.

The spatially non-uniform intensity may correspond to a set of regions in which the peak emitted intensity is substantially constant and/or in which the peak emitted intensity is at least 50% of a maximum intensity level. The set of regions may together cover between 1% and 50% of the sensor surface at a given instant of time. The set of regions may together cover more than 10% and less than 50% or less than 40% or less than 30% or less than 20% of the sensor surface at a given instant of time. The set of regions may together cover more than 20% and less than 50% or less than 40% or less than 30% of the sensor surface at a given instant of time. The set of regions may together cover more than 30% and less than 50% or less than 40% of the sensor surface at a given instant of time. The set of regions may together cover more than 40% and less than 50% of the sensor surface at a given instant of time. The set of regions may be arranged such that the movement of the spot illumination causes the set of regions to cover more than 75% or more than 90% or substantially all of the sensor surface during a cycle of the scanning pattern. The set of regions may be arranged such that the movement of the spot illumination substantially avoids regions of the set of regions covering the same part of the sensor surface more than once during a cycle of the scanning pattern.

The movement of the spot illumination may cause a particular point in the spatially non-uniform intensity to move by less than 50% or less than 40% or less than 30% or less than 20% or less than 10% or less than 5% of a width or height of the sensor surface during a cycle of the scanning pattern. The set of regions may have a periodicity in at least one direction of the sensor surface and the movement of the spot illumination may cause a particular point in the spatially non-uniform intensity to move by approximately the inverse of the periodicity in the at least one direction. The set of regions may comprise a periodicity which includes a predetermined distance in at least one direction, and the spatially non-uniform illumination may be moved by the inverse of the predetermined distance in the at least one direction. For example, the at least one direction may comprise a plurality of consecutive directions, which may be different directions.

The sensor may comprise a plurality of pixels and may be further configured to provide data from scattered light sensed from only those pixels of the plurality of pixels of the sensor that have a field of view within the set of regions at a given instant of time.

The spot illumination may have any form or shape. For example, the spot illumination may comprise: a light beam having a beam projection configured to tessellate, a light beam having a circular or polygonal beam projection, a pattern of parallel stripes of light, or a pattern of dots or circles of light, such as a pattern of uniform or non-uniform dots or circles of light. It will be understood that these are merely example types of illumination and are non-limiting. By tessellate, it is meant that the beam shape is configured to substantially cover the sensor surface when moving the spot illumination without the beam shape overlapping. This may be without gaps between the projections, or there may be gaps between projections.

The optical system may be configured to determine, for the illumination, which of spot illumination or flood illumination to provide. The optical system may determine the optimum type of illumination to provide depending on the required application. The optical system may determine which of spot illumination or flood illumination to provide based on one or more of a desired range of illumination, a desired resolution of the generated image, or a desired frame rate. Such desired parameters may be input by a user, may be selection of an application, or may be determined by the sensor system itself. The optical system may determine which of flood illumination or spot illumination to provide based on a mode of operation of the time-of-flight sensor system. For example, the mode of operation of the time-of-flight sensor system may be determined by a device or system into which the time-of-flight sensor system is incorporated or being used. For example, the mode of operation of the time-of-flight sensor system may be determined based on an application running on a device in which the sensor system is implemented. The mode of operation may comprise one of: a facial recognition mode, an operation mode of an application, a virtual reality gaming operation mode, or a portrait photography operation mode. For example, the optical system may determine that an operation mode has been set or has changed, and the optical system may then determine the appropriate or optimum illumination mode for that mode of operation. The optical system may then defocus or focus and optionally dotscan the illumination source using the at least one actuator to provide the optimum illumination mode.

The spot illumination may comprise one or more spots, and a ratio of intensity of illumination at the one or more spots to intensity of illumination between the one or more spots may be or greater, such as 30 or greater. The flood illumination may comprise a ratio of intensity of illumination at spots of the flood illumination to intensity of illumination between the spots of the flood illumination of 2 or less, such as 1.5 or less.

Optionally, the optical system is configured to move the spot illumination in a continuous manner during which the sensor senses the scattered light. For example, the spot illumination may move in a continuous motion along a direction, or multiple directions in a scanning pattern across at least part of the sensor surface.

Alternatively, the optical system is configured to pause or cease movement of the spot illumination at plural predetermined positions, or intermediate positions, along a path of movement so as to allow the sensor to sense the scattered light at the predetermined positions, and to resume movement along the path of movement once the sensor has finished sensing the scattered light. Optionally, the spot illumination sequentially moves across the plural predetermined positions along the path of movement, wherein scattered light sensed at all the plural predetermined positions are required to generate the output frame. For example, when moving the spot illumination along a direction, or each of plural directions in a scanning pattern, the actuator may stop or pause at each of the predetermined positions, e.g. a point of interest or an area of interest that corresponds to a pixel or a group of pixels on the sensor surface. This allows the sensor to sense scattered light when the spot illumination is held stationary at the predetermined position, and not between the said predetermined positions.

Advantageously, such an arrangement may improve the accuracy of the time-of-flight measurement by maximising the measured signal-to-noise ratio. It is particularly desirable to maximise the signal-to-noise ratio in long-range measurements, as they are more susceptible to the presence of noise.

More specifically, for a given pixel on the sensor, scattered light is originated from both the signal source and any noise sources. In known systems where the spot illumination continuously moves across a path of movement, e.g. scattered light is sensed at locations in between the predetermined positions, the sensor may sense a high level of scattered light originated from noise sources (in some cases the scattered light may originate solely from noise sources) for a significant portion of sensing time or exposure time, e.g. up of half of the exposure time, which may negatively impact the accuracy of the time-of-flight measurement.

In order to maximise the signal-to-noise ratio, it is desirable to sense scattered light that originates from the signal source. Therefore, by pausing the movement in the spot illumination and holding it stationary during sensing, the signal-to-noise ratio may be maximised.

Advantageous, the use of SMA actuator may be particularly suitable for pausing and resuming movement of the spot illumination, in comparison to other type of actuators such as a voice coil motor (VCM).

Optionally, the sensor is configured to sense scattered light only when the spot illumination has moved to, and being stationary at, the predetermined positions. Alternatively, the sensor is configured to sense scattered light in a continuous manner, and wherein only the scattered light that is sensed when the spot illumination has moved to, and held stationary at, the predetermined positions is used for generating an output frame. That is, in the latter case, data from scattered light that is sensed away from the predetermined positions may be discarded.

The invention has particular advantages when applied to a miniature camera, for example where the camera lens element comprises one or more lenses having a diameter of no more than 10 mm, such as in a mobile phone.

According to another aspect of the present invention, there is provided a time-of-flight sensor system comprising: an illumination source for illuminating a subject to which a time-of-flight is to be measured; a sensor comprising a sensor surface, the sensor being configured to sense light scattered by the subject from the illumination source and to provide data dependent on sensed light; and an optical system configured to focus the illumination source for providing spot illumination, the spot illumination having a spatially non-uniform intensity over the sensor surface, and the optical system is configured to move the spot illumination across at least part of the sensor surface to generate an output frame; wherein during the said moving, the optical system is configured to pause or cease movement at plural predetermined positions along a path of movement so as to allow the sensor to sense the scattered light at the predetermined positions, and to resume movement along the path of movement once the sensor has sensed the finished sensing the scattered light.

According to another aspect of the present invention, there is provided a method of sensing light scattered from a subject for a time-of-flight sensor system, the method comprising: determining, for an illumination source, which of flood illumination or spot illumination to provide; the illumination source illuminating the subject with the determined flood illumination or spot illumination; and a sensor sensing light scattered by the subject from the illumination source and providing data dependent on the sensed light, the sensor comprising a sensor surface, wherein the spot illumination has a spatially non-uniform intensity over the sensor surface, and when the illumination source provides spot illumination, moving the spot illumination across at least part of the sensor surface to generate an output frame.

Optionally, the method further comprises: pausing or ceasing movement of the spot illumination at plural predetermined positions along a path of movement; sensing the scattered light at the predetermined positions, and resuming movement along the path of movement once the sensor has finished sensing the scattered light.

According to another aspect of the present invention, there is provided a method of sensing light scattered from a subject for a time-of-flight sensor system, the method comprising: the illumination source illuminating the subject with the spot illumination; and a sensor sensing light scattered by the subject from the illumination source and providing data dependent on the sensed light, the sensor comprising a sensor surface, wherein the spot illumination has a spatially non-uniform intensity over the sensor surface, and when the illumination source provides spot illumination, moving the spot illumination across at least part of the sensor surface to generate an output frame; wherein the method further comprises pausing or ceasing movement of the spot illumination at plural predetermined positions along a path of movement; sensing the scattered light at the predetermined positions, and resuming movement along the path of movement once the sensor has finished sensing the scattered light.

According to another aspect of the present invention, there is provided a computer program for instructing a computer to perform the method set out above. The computer program code may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

According to another aspect of the present invention, there is provided a non-transitory computer-readable medium comprising instructions for performing the method set out above. The non-transitory computer-readable medium may be, for example, a solid state memory, a microprocessor, a CD or DVD-ROM, programmed memory such as non-volatile memory (such as Flash), or read-only memory (firmware), or on a data carrier such as an optical or electrical signal carrier.

According to another aspect of the present invention, there is provided an actuation apparatus for a time-of-flight sensor system, the actuation apparatus comprising: a moveable element moveable, relative to a support structure, along a movement axis between a first position and a second position; and a shape memory alloy component connected between the moveable element and the support structure and being configured to, on contraction, move the moveable element between the first position and the second position; wherein the support structure comprises support portions configured to prevent the movement of the moveable element from moving beyond the first position and the second position.

The shape memory alloy actuation apparatus may be, or may be provided in, any one of the following devices: a smartphone, a camera, a foldable smartphone, a foldable smartphone camera, a foldable image capture device, an array camera, a 3D sensing device or system, a servomotor, a consumer electronic device (including domestic appliances such as vacuum cleaners, washing machines and lawnmowers), a mobile or portable computing device, a mobile or portable electronic device, a laptop, a tablet computing device, an e-reader (also known as an e-book reader or e-book device), a computing accessory or computing peripheral device (e.g. mouse, keyboard, headphones, earphones, earbuds, etc.), an audio device (e.g. headphones, headset, earphones, etc.), a security system, a gaming system, a gaming accessory (e.g. controller, headset, a wearable controller, joystick etc.), a robot or robotics device, a medical device (e.g. an endoscope, inhaler, drug dispenser, etc.), an augmented reality system or device, a virtual reality system or device, a wearable device, a drone (aerial, water, underwater, etc.), an aircraft, a spacecraft, a submersible vessel, a vehicle, an autonomous vehicle (e.g. a driverless car), a tool, a surgical tool, a display screen, and a touchscreen.

According to another aspect of the present invention, there is provided a method for an actuation apparatus in a time-of-flight sensor system, the method comprising: a shape memory alloy component moving, on contraction, a moveable element relative to a support structure between a first position and a second position along a movement axis, wherein the movement of the moveable element is prevented from moving beyond the first position and the second position by support portions of the support structure.

Contrary to the teaching of the prior art, it has been appreciated that a time-of-flight (TOF) sensor system can be provided in which each pixel of the system's sensor has an area larger than the area of the sensor surface illuminated by a sensed spot of light, and in which each of the sensed spots of light illuminating the sensor surface can be moved, in a scanning step, by an optical system across the sensor surface by a distance less than a distance spanned by a pixel of the one or more pixels. The overall distance from multiple scanning steps, however, may span by more than a single pixel.

It has been appreciated that providing a TOF system with pixels that are larger than the spot size, and with an optical system capable of moving the spots by sub-pixel distances, allows for more efficient collection of sensor data. For example, by using spots of sub pixel sizes, the number of spots can be matched to the number of pixels. Further, providing an optical system configured to move a spot by a sub-pixel distance improves the precision of the scanning process (in which spots can be moved across the sensor face). Both allow for a large proportion, if not all, of the pixels of the sensor to be illuminated during each scanning, and also that no pixels, or at least fewer pixels, are missed from illumination between scans in comparison to prior art methods. This results in a reduced number of pixels, which contain no useful information, being read out by the system. This improves efficiency.

This set up also allows for larger pixel sizes to be utilised compared to traditional TOF systems without an unacceptable drop in pixel resolution—i.e. when fewer number of pixels are used more effectively. The use of large pixels further improves efficiency as larger pixels are superior at collecting light compared to smaller pixels.

Further, the above set up allows for a spot illumination to illuminate an area of the sensor that is within the bounds of a pixel and to be moved to different locations within the bounds of that single pixel. In one example, a separate output frame is generated for each spot location within a pixel. These frames are then combined to produce an even higher resolution final frame that is achievable by the prior art technique. In a more specific example, a grid (or an array) of spots can be provided that has been calibrated to match an array of pixels, so that each spot illuminates an area contained within the bounds of a respective pixel. The array of spots can then be moved to different positions within each respective pixel, with an output frame being generated for each position. The frames are then combined to produce a higher resolution final frame. In such a case, every pixel may have contributed meaningful information for every scan position. This in itself improves efficiency of the system. Beyond this efficiency gain, the resolution of the final frame is improved as the frames for each scan position are combined to produce a super-resolution image. Thus, the above system allows for resolution to be improved for a given number of pixels, or for pixel number to be reduced (allowing for the use of larger pixels) without a drop in final resolution.

The invention in its various aspects is defined in the independent claims below to which reference should now be made. Optional features are set forth in the dependent claims.

Arrangements are described in more detail below. According to another aspect, there is provided a time-of-flight sensor system comprising an illumination source, a sensor, and an optical system. The illumination source is configured to illuminate a subject to which a time-of-flight is to be measured. The illumination is spot illumination comprising one or more spots of light. The sensor comprises a sensor surface having one or more pixels. The sensor is configured to sense one or more spots of light, scattered by the subject from the illumination source, that each illuminates a respective first area of the sensor surface. Each pixel of the one or more pixels has an area larger than the first area of the sensor surface illuminated by a sensed spot of light. The sensor is further configured to provide a data set dependent on the one or more sensed spots of light. The provided data set is for generation of an output frame reflecting each first area of the sensor surface illuminated by the one or more sensed spots of light. The optical system is configured in relation to the illumination source to move, using at least one actuator, the spot illumination relative to the subject such that each of the one or more sensed spots of light moves to illuminate a respective second area of the sensor surface, wherein the at least one actuator comprises at least one shape memory alloy (SMA) component. The distance moved by each of the one or more spots of light is less than a distance spanned by a pixel of the one or more pixel.

The time-of-flight sensor may be configured to use the data set to generate an output frame reflecting each first area of the sensor surface illuminated by the one or more sensed spots of light. The sensor may be configured to, each time the optical system engages the illumination source to move the spot illumination relative to the subject, provide a second data set dependent on the moved one or more sensed spots of light. The time-of-flight sensor system may be configured to generate a second output frame using each second data set, each second output frame reflecting the second areas of the sensor surface illuminated by the respective moved one or more sensed spots of light. The time-of-flight sensor system may be configured to combine two or more output frames to produce a final output frame. The final output frame may have a resolution equal to the sum of the resolutions of the each combined output frame.

Each respective area of the sensor surface illuminated by a sensed spot of light may be equal to the respective first area of the sensor surface and may be within the bounds of a corresponding pixel of the one or more pixels. The optical system may be configured to engage the illumination source to move the spot illumination relative to the subject such that each respective second area illuminated by a moved spot of light remains within the bounds of the corresponding pixel, and preferably such that corresponding first and second areas do not overlap.

The one or more pixels may comprise an array of pixels and the distance spanned by a pixel may comprise the pixel pitch for the pixels of the array.

The one or more sensed spots of light may comprise a spot pattern made up of a plurality of spots of light. The number of sensed spots of light in the spot pattern may correspond to the number of pixels. In one particular example, the one or more pixels comprises an array of pixels and the distance spanned by a pixel comprises the pixel pitch for the pixels of the array, wherein the one or more sensed spots of light comprises a spot pattern made up of a grid of spots of light that corresponds to the array of pixels such that each sensed spot of light illuminates an area of the senor surface that is within the bounds of a respective pixel in the array.

The optical system is configured to move the spot illumination in a scanning pattern across at least part of the sensor surface. The scanning pattern may comprise moving the spot illumination along a first direction across at least part of the sensor surface. The scanning pattern may further comprise moving the spot illumination along a second direction across at least part of the sensor surface. the first direction may be perpendicular to the second direction or angled to the second direction in a plane.

The optical system may be configured to move the spot illumination relative to the source using an actuator. The actuator may comprise a shape-memory alloy actuator, a voice coil motor or a microelectromechanical systems magnetic actuator. The optical system may comprise a diffraction element, for example diffraction grating, for splitting the input light beam into, for example, a pattern 3×3 array. The optical system may comprise a lens for focussing the one or more spots of light onto the subject. The optical system may be configured to move the spot illumination relative to the source by the actuator engaging the lens to move the lens relative to the illumination source to move the spot illumination relative to the subject.

The illumination source may comprise a dot projector. The time-of-flight sensor system comprises a processor.

The spot illumination may comprise a ratio of intensity of illumination at the spots to intensity of illumination between the spots of 20 or greater, such as 30 or greater. The spots of light may comprise a set of regions in which the peak emitted intensity is substantially constant and/or in which the peak emitted intensity is at least 50% of a maximum intensity level. The set of regions together may cover between 1% and 50% of the sensor surface at a given instant of time, optionally wherein the set of regions together cover more than 10% and less than 50% or less than 40% or less than 30% or less than 20% of the sensor surface at a given instant of time, optionally wherein the set of regions together cover more than 20% and less than 50% or less than 40% or less than 30% of the sensor surface at a given instant of time, optionally wherein the set of regions together cover more than 30% and less than 50% or less than 40% of the sensor surface at a given instant of time, and optionally wherein the set of regions together cover more than 40% and less than 50% of the sensor surface at a given instant of time. The set of regions may be arranged such that the movement of the spot illumination causes the set of regions to cover more than 75% or more than 90% or substantially all of the sensor surface during a cycle of a scanning pattern.

The spot illumination may comprise: a light beam having a beam projection configured to tessellate, a light beam having a circular or polygonal beam projection, a pattern of parallel stripes of light, or a pattern of dots or circles of light.

According to another aspect of the presently-claimed invention, there is provide a method of sensing light scattered from a subject for a time-of-flight sensor system, the method comprising: illuminating a subject to which a time-of-flight is to be measured with an illumination source, wherein the illumination is spot illumination comprising one or more spots of light; sensing using a sensor comprising a sensor surface having one or more pixels, the sensor being configured to: sense one or more spots of light, scattered by the subject from the illumination source, that each illuminate a respective first area of the sensor surface, wherein each pixel of the one or more pixels has an area larger than the first area of the sensor surface illuminated by a sensed spot of light, and provide a data set dependent on the one or more sensed spots of light, the provided data set being for generation of an output frame reflecting each area of the sensor surface illuminated by the one or more sensed spots of light; and moving, using a least one actuator, a lens relative to illumination source to move the spot illumination relative to the subject such that each of the one or more sensed spots of light moves to illuminate a respective second area of the sensor surface, the distance moved by each of the one or more spots of light being less than a distance spanned by a pixel of the one or more pixels, wherein the at least one actuator comprises at least one shape memory alloy (SMA) component.

According to another aspect of the presently-claimed invention, there is provided a computer program for instructing a computer to perform the method of the second aspect. According to a fourth aspect of the presently-claimed invention, there is provided a non-transitory computer-readable medium comprising instructions for performing the method of the second aspect. The non-transitory computer-readable medium may be, for example, solid state memory.

According to another aspect, there is provided a sensor for a time of flight sensor system comprising a sensor surface having one or more pixels, the sensor being configured to: sense a first set of one or more spots of light, scattered by a subject from an illumination source, that illuminates a first set of one or more respective areas of the sensor surface, wherein each pixel of the one or more pixels has an area larger than the area of the sensor surface illuminated by a sensed spot of light, provide a data set dependent on the first set of one or more sensed spots of light, the provided data set being for generation of a first output frame reflecting each area of the first set of one or more respective areas illuminated by the first set of one or more sensed spots of light; and sense a second set of one or more spots of light, scattered by a subject from an illumination source, that illuminates a second set of one or more respective areas of the sensor surface, wherein each pixel of the one or more pixels has an area larger than the area of the sensor surface illuminated by a sensed spot of light; wherein, the second set of one or more spots of light has moved across the sensor surface relative to the first set of one or more spots of light by a distance less than a distance spanned by a pixel of the one or more pixels provide a data set dependent on the second set of one or more sensed spots of light, the provided second data set being for generation of a second output frame reflecting each area of the second set of one or more respective areas illuminated by the second set of one or more sensed spots of light. Here, the first and second output frames may be combined to produce a final output frame with a resolution equal to the sum of the resolutions of the first and second output frame. The second set of one or more spots of light for providing the second data set and hence for generation of the second output frame may be N set of one or more spots of light for providing an N data set and hence for generation of an N output frame, where N is the number of output frames for combining with N−1 output frame . . . , and the first output frame. N may be at least three.

According to another aspect, there is provided a method of sensing light scattered from a subject for a time-of-flight sensor system, the method comprising: sensing using a sensor comprising a sensor surface having one or more pixels, the sensor being configured to: sense a first set of one or more spots of light, scattered by a subject from an illumination source, that illuminates a first set of one or more respective areas of the sensor surface, wherein each pixel of the one or more pixels has an area larger than the area of the sensor surface illuminated by a sensed spot of light, provide a data set dependent on the first set of one or more sensed spots of light, the provided data set being for generation of a first output frame reflecting each area of the first set of one or more respective areas illuminated by the first set of one or more sensed spots of light; and sense a second set of one or more spots of light, scattered by a subject from an illumination source, that illuminates a second set of one or more respective areas of the sensor surface, wherein each pixel of the one or more pixels has an area larger than the area of the sensor surface illuminated by a sensed spot of light; wherein, the second set of one or more spots of light has moved across the sensor surface relative to the first set of one or more spots of light by a distance less than a distance spanned by a pixel of the one or more pixels provide a data set dependent on the second set of one or more sensed spots of light, the provided second data set being for generation of a second output frame reflecting each area of the second set of one or more respective areas illuminated by the second set of one or more sensed spots of light. Here, the first and second output frames may be combined to produce a final output frame with a resolution equal to the sum of the resolutions of the first and second output frame.

According to another aspect, there is provided, an image processing method comprising receiving a first set of data indicative of a first set of one or more spots of light sensed by a sensor, the first set having illuminated a first set of one or more respective areas of a sensor surface of the sensor; generating a first output frame reflecting each area of the first set of one or more respective areas illuminated by the first set of one or more sensed spots of light; receiving a second set of data indicative of a first set of one or more spots of light sensed by the sensor, the second set having illuminated a second set of one or more respective areas of the sensor surface; generating a second output frame reflecting each area of the second set of one or more respective areas illuminated by the second set of one or more sensed spots of light; combining the first and second output frame to produce a final frame reflecting the areas of the first and second set of areas illuminated by the first and second sets of spots of light, thereby providing a final frame of a higher resolution than each of the first and second output frames.

Features from one aspect of the present invention may be used combined with other aspects of the present invention.

### BRIEF DESCRIPTION OF THE DRAWINGS

Certain embodiments of the presently-claimed invention will now be described, by way of example only, with reference to the accompanying drawings, in which:

FIG. 1a is a schematic drawing of a time-of-flight sensor system embodying an aspect of the present invention;

FIG. 1b is an exploded perspective view of an actuation apparatus suitable for use with the time-of-flight sensor of FIG. 1a;

FIGS. 2a and 2b are schematic drawings of various illumination patterns embodying an aspect of the present invention;

FIGS. 2c and 2d are graphs illustrating the change in velocity in a spot illumination as shown in FIG. 2b;

FIG. 3a is a schematic drawing of an actuation apparatus embodying an aspect of the present invention;

FIG. 3b is a schematic drawing of an actuation apparatus embodying an aspect of the present invention;

FIG. 3c is a schematic drawing of an actuation apparatus embodying an aspect of the present invention;

FIG. 3d is a schematic drawing of an actuation apparatus embodying an aspect of the present invention;

FIG. 4 is a schematic drawing of an actuation apparatus embodying an aspect of the present invention;

FIG. 5a is a schematic drawing of an actuation apparatus embodying an aspect of the present invention;

FIG. 5b is a schematic drawing of an actuation apparatus embodying an aspect of the present invention; and

FIG. 5c is a schematic drawing of an actuation apparatus embodying an aspect of the present invention;

FIG. 6 (prior art) is a schematic representation of a method of scanning the surface of a sensor with spot illumination;

FIG. 7 is a schematic diagram of a time-of-flight sensor system embodying an aspect of the present invention;

FIG. 8 is a schematic diagram illustrating movement of a spot pattern across a 3D scene;

FIG. 9 is a schematic representation of a method of scanning the surface of a sensor with spot illumination embodying an aspect of the invention; and

FIG. 10 is a schematic representation of a method of image processing embodying an aspect of the invention.

Like features are denoted by like reference numerals.

### DETAILED DESCRIPTION

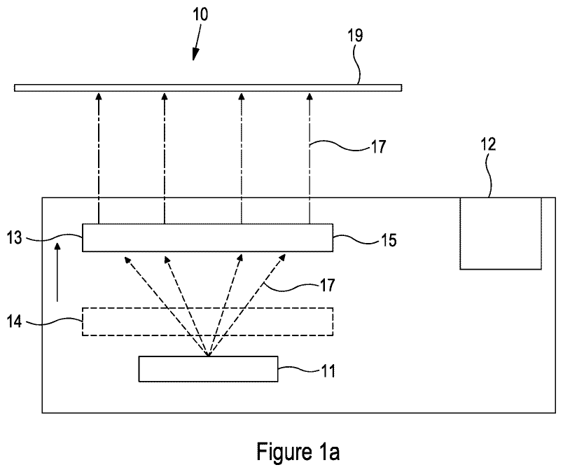

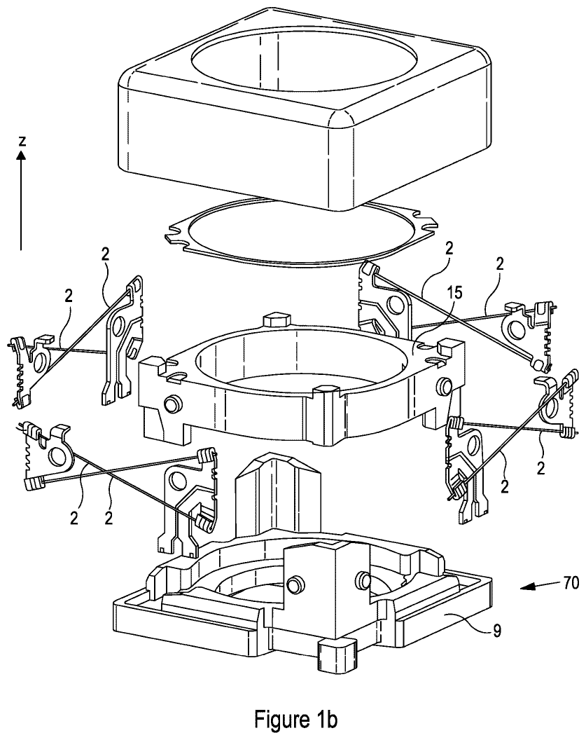

An example time-of-flight sensor system will now be described with reference to FIGS. 1 to 5c.

FIG. 1a illustrates a time-of-flight sensor system 10. The system 10 comprises an illumination source which in this example is dot projector formed by a vertical cavity surface emitting laser (VCSEL) array 11, for illuminating a subject 19 to which a time-of-flight is to be measured. The system also comprises an optical system configured to transition the VCSEL array 11 between providing spot illumination and flood illumination. In this example, the optical system comprises a moveable element which here is a lens element 15. The lens element 15 is moveable between a first position 13 and a second position 14 spaced from the first position 13 by a distance, to focus and defocus the illumination source respectively, thereby providing respective spot illumination and flood illumination. The optical system comprises a diffraction grating (not shown) located between the lens element 15 and the subject 19. The diffraction grating diffracts light from the lens component 15 and, in particular, focused light from the lens component 15 to provide more spots on the subject 19 when in the illumination source is in a spot illumination mode. This increases resolution, which is dependent on the number of spots.

The system 10 also comprises a sensor 12 comprising a sensor surface. The sensor 12 is configured to sense light scattered by the subject 19 from the VCSEL array 11 and to provide data dependent on the sensed light.

The example time-of-flight system 10 illustrated in FIG. 1a is implemented in smartphone device, but it will be understood that the time-of-flight system could be implemented in any appropriate system. In the example illustrated in FIG. 1a, the lens element 15 has been moved from the second position to the first position, thereby focusing the VCSEL array 11 and thus providing spot illumination to illuminate the subject 19. The type of illumination to provide is determined by the optical system. The optical system determines the type of illumination to provide based on a mode of operation of the smartphone device. In this example, an application running on the smartphone device required illumination capable of achieving long-range (relative to flood illumination capabilities). Spot illumination is capable of achieving such long ranges and thus the lens element 15 was moved to focus the illumination source.

Light 17 is emitted from the VCSEL array 11 and is focused by the lens element 15 onto the subject 19. The spot illumination provided by the VCSEL array 11 has a spatially non-uniform intensity over the sensor surface.

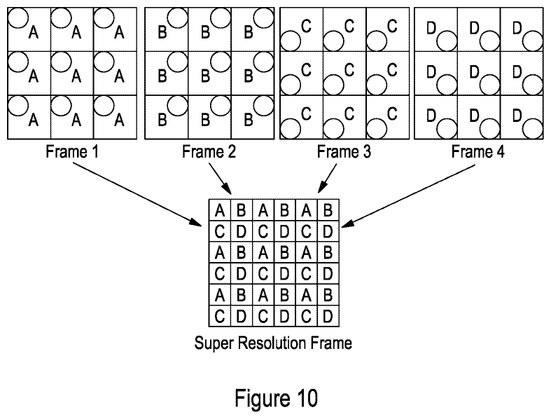

FIG. 1B is a perspective view of an actuation apparatus 70 suitable for use with the time-of-flight sensor of FIG. 1A. FIGS. 1B and 10 show an embodiment of an actuator assembly 70 that comprises eight SMA wires 2 connecting a moveable element (e.g. a lens element 15) to a support structure 9. This arrangement may drive movement in the lens element 15 in a direction along the optical axis to switch between flood illumination and spot illumination, and additionally in a direction orthogonal to the optical axis to move the spot illumination across the subject 19. The SMA wires 2 may be connected to lens element 15 and to support structure 9 using any suitable method. For example, the SMA wires 2 may be coupled using crimps to provide a mechanical and electrical connection. Two SMA wires 2 are connected to each of the four side faces of the lens element. FIGS. 1A and 1B show a possible arrangement of the 8 SMA wires. Other arrangements of the eight SMA wires 2 are possible as detailed in international patent publication numbers WO2011/104518, WO2012/066285, WO2014/076463, and WO2017/098249.

The lens element 15 may comprise one or more lenses whose optical axes lie parallel to the z-direction as shown in FIG. 1B. A control system (e.g. control module described above) may be able to adjust the position of the lens element 10 by targeting pre-determined values of SMA wire resistance that are known to correspond to specific positions of the lens element in the z-direction. The position in the z-direction may be varied by varying the length of the SMA wires. As an example, in the arrangement shown in FIG. 1B, movement in the positive z-direction may be performed by increasing the length of four SMA wires 2 (by decreasing their temperature) and decreasing the length of four SMA wires 2 (by increasing their temperature). The opposite operation will result in movement in the negative z-direction. Movement in the z-direction allows the time-of-flight system to switch between flood illumination and spot illumination.

Additionally, the spot illumination may scan across the subject 19 by shifting the lens element 15 along the x-y plane perpendicular to the z-axis. The use of eight SMA actuator wires 2 for permitting the said lateral movement is described in international patent publication numbers WO2011/104518, WO2012/066285, WO2014/076463, and WO2017/098249.

The control system may set target SMA wire resistance values for all SMA wires 2 and that correspond to the desired position of the lens element. Closed-loop feedback control may be performed using the target SMA wire resistance values with the real-time SMA wire resistance measures to set the electrical drive power through the SMA wires 2 in real-time. The target values of SMA wire resistance values set by the control system can be extracted from a look-up table of pre-determined calibrated values stored inside the memory of the control system. These pre-determined values can be determined during manufacture or during a start-up procedure performed after every initialisation of the SMA actuator or a combination of both.

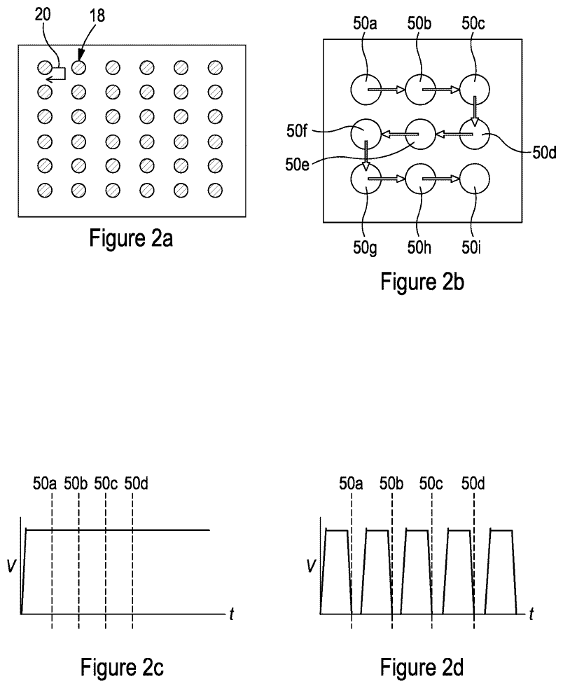

The spot illumination used in this example is illustrated in FIG. 2a. In this example, the spot illumination comprises a pattern of dots of light. However, it will be understood that any beam shape may be used, as described above. The spatially non-uniform intensity of the spot illumination corresponds to a set of regions 18 in which the peak emitted intensity is substantially constant. In this example, the set of regions 18 together cover between 40% and 50% of the sensor surface at any given time. The ratio of intensity of illumination at the dots of light to the intensity of illumination between the dots of light is greater than 30, and may depend on the ambient/background noise.

The optical system is configured to move the spot illumination across at least part of the sensor surface to generate an output frame. The movement of the spot illumination is caused by an at least one actuator, which in this example is a single actuator (not shown). The actuator moves the spot illumination in a scanning pattern across at least part of the sensor surface. In this example, the scanning pattern 20 comprises moving the spot illumination in a first direction, a second direction, and a third direction, where the first and third directions are parallel and are perpendicular to the second direction. The scanning pattern 20 optionally comprises a forth direction to return the spot illumination to its starting position. Movement in the three (or four) directions makes up a scanning cycle of the scanning pattern.

The set of regions 18 are arranged such that the movement of the spot illumination causes the set of regions 18 to cover more than 90% of the sensor surface during a cycle of the scanning pattern. The set of regions 18 are also arranged such that the movement of the spot illumination substantially avoids regions of the set of regions 18 covering the same part of the sensor surface more than once during a cycle of the scanning pattern.

In the same time-of-flight sensor system 10, the system 10 is capable of adapting to different applications. While in this example the system 10 provides spot illumination including dotscan sensing (moving the spot illumination across at least part of the sensor surface), the system 10 is equally capable of providing flood illumination, by moving the lens component to the second position 14.

FIG. 2B is a schematic drawing of another illumination pattern for scanning a 3×3 array of regions of interest. As shown in the illustration, the spot illumination moves in a raster scanning pattern where the spot illumination scans across a first row of regions 50a,50b,50c in a first direction, before continuing to scan subsequent rows of regions 50d-50f, 50g-50i by moving in other directions. Each of the regions 50a-50i is a predetermined position at which scattered light is sensed for producing an output frame, e.g. a single output frame.

In one embodiment according to the present invention, the spot illumination moves sequentially across each of the regions 50a-50i by a continuous motion. Therefore, as shown in FIG. 2c, the velocity of movement remains substantially constant throughout the movement. Such an arrangement is time-efficient, e.g. the spot illumination can promptly move across all of the regions 50a-50i.

During the continuous movement of the spot illumination, the sensor 12 continuously senses scattered light, and therefore, the sensor 12 may sense scattered light when the spot illumination is moving between the regions 50a-50i, e.g. at positions where the spot illumination may not be perfectly aligned at the regions 50a-50i. Therefore, such techniques may have a drawback in that the sensor 12 may sense a substantial amount of scatted light originated from noise sources other than the VCSEL array 11 (in some cases the scattered light may originate solely from noise sources) for a significant portion of sensing time or exposure time, e.g. up of half of the exposure time, which may negatively impact the accuracy of the time-of-flight measurement.

Alternatively, in another embodiment according to the present invention, the movement of the spot illumination pauses at each of the regions 50a-50i along a path of movement, so as to allow the sensor 12 to sense the scattered light at each of the regions 50a-50i, as illustrated in the representation in FIG. 2d. For example, when the spot illumination moves in the first direction from region 50a to region 50c, the movement of the spot illumination pauses at region 50b to allow sensing of scattered light thereat, instead of scanning by the “on the fly” method, e.g. by a continuous motion, as applied in the previous embodiment. Similarly, in the event of a change in direction, e.g. when moving spot illumination from region 50b to region 50d, the movement of the spot illumination pauses at region 50c to allow sensing of scattered light thereat.

Since the scattered light is sensed when the spot illumination is substantially aligned with the target regions, the signal-to-noise ratio in the sensed scatter light is significantly improved in comparison to the previous embodiment. The spot illumination resumes movement once the sensor has finished sensing the scattered light. That is, the spot illumination moves sequentially across each of the regions 50a-50f, whilst pausing at each of the regions 50a-50f.

In some embodiments, the sensor 12 is configured to sense scattered light only when the spot illumination has moved to, and being held stationary at, the regions 50a-50i. Thus, the sensor 12 and the actuation apparatus 70 are synchronised so that the sensor 12 operates only when the movement of the spot illumination ceases at each of the regions 50a-50i.

In other embodiments, the sensor 12 is configured to sense scattered light in a continuous manner, and wherein only the scattered light that is sensed when the spot illumination has moved to, and held stationary at, the regions 50a-50i is used for generating an output frame. For example, the sensor 12 may sense scattered light even when the spot illumination is not aligned. However, such data may be discarded and not used for generating an output frame. Such an arrangement may reduce the degree of synchronisation required between the sensor 12 and the actuation apparatus 70.

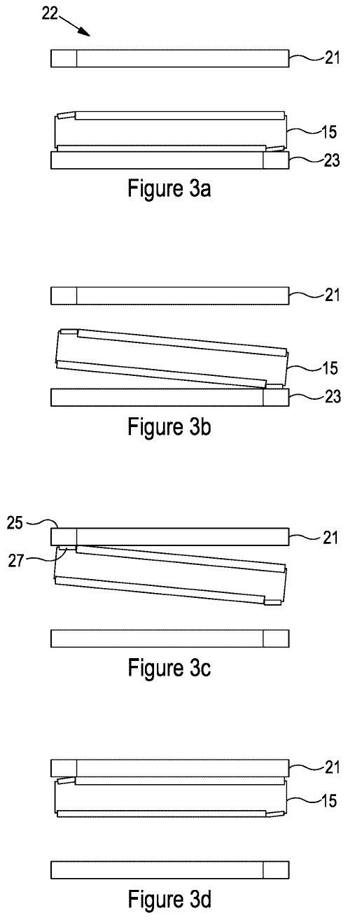

FIGS. 3a to 3d illustrate in detail an actuation apparatus 22 in use, including the movement of the lens component 15 from the second position 14, at which the illumination source is defocused and provides flood illumination, to the first position 13 at which the illumination source is focused and provides spot illumination.

FIG. 3a illustrates the lens component 15, and a support structure comprising support portions, which in this example are endstops 21, 23. FIG. 3a illustrates an example in which the lens component 15 is initially situated at the second position, thereby defocusing the light source 11 such that the illumination source 11 provides flood illumination. In the second position, the lens component 15 is in contact with, and is substantially parallel with, the endstop 23. In this example, the lens component 15 is retained in the second position against the endstop 23 by a flexures (not shown). However, it will be understood that the lens component 15 may be retained in the second position by an SMA component.

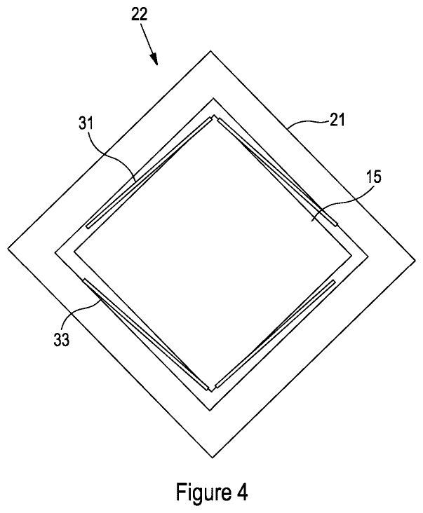

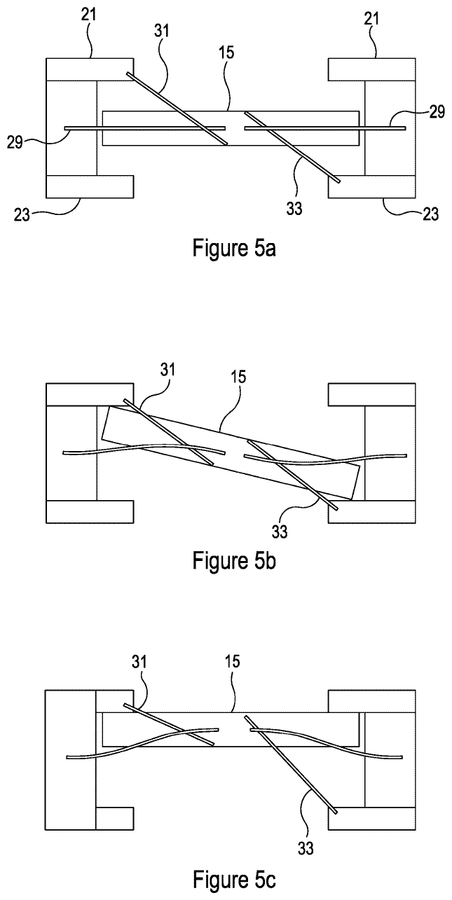

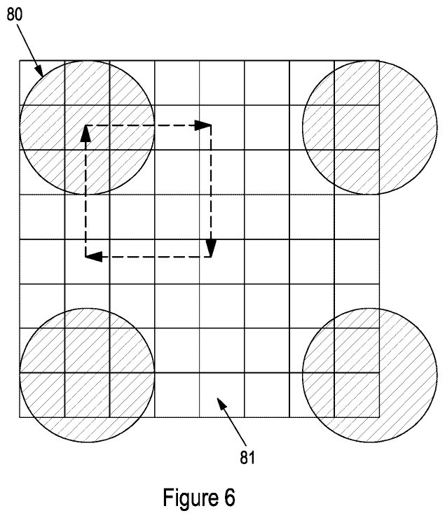

FIG. 3b illustrates the situation when the optical system has determined that the illumination source 11 must provide spot illumination, rather than flood illumination, and thus the lens component 15 must be moved from the second position to the first position. The actuation apparatus 22 comprises an SMA wire (illustrated in FIGS. 4 to 5c). The SMA wire is heated by electrical current, causing it to contract. The SMA wire is connected between the moveable element and the support structure such that, on contraction, the SMA wire moves the moveable element from the second position to the first position.

The lens component 15 is orientated at a non-zero angle to the orientation of the endstops 21, 23, such that when the lens component 15 moves between the second position and the first position a first portion 27 of the lens component 15 contacts the endstop 21 before a second portion of the lens component 15, causing the lens component 15 to be tilted about a rotation axis.

FIG. 3c illustrates the point at which the lens component 15 reaches the endstop 21 due to contraction of the SMA wire and the first portion 27 of the lens component contacts a contact portion 25 of the endstop 21. By orientating the lens component 15 at an angle such that the first portion 27 contacts the endstop 21 first, the audible noise output is reduced. In addition, the audible noise output produced by the lens component 15 contacting the endstop 21 is further reduced as the endstops 21, 23 are coated in a hysteric gel.

FIG. 3d illustrates the lens component 15 having reached the first position. The contraction of the SMA wire caused the lens component 15, having first contacted the endstop 21, to rotate about a rotation axis and contact the endstop 21 such that the lens component 15 and the endstop 21 are substantially parallel. In this example, similarly to the situation illustrated in FIG. 3a, the lens component 15 is retained in the first position by flexures (not shown). This therefore enables heat to be removed from the SMA wire when the lens component 15 is in the first position, thus reducing the power consumption of the actuation apparatus.

The endstops 21, 23 prevent the lens component 15 from moving beyond the first position and the second position. That is, they provide limits on the movement of the lens component 15. On contraction of the SMA wire, the lens component 15 is moved position but cannot move beyond the limits of the endpoints 21, 23. Thus, the SMA wire may be configured to contract quickly, thereby moving the lens component quickly. For example, the lens component 15 may be moved between the second position and the first position in less than 3 ms.

FIG. 4 illustrates a top view of the actuation apparatus 22. The actuation apparatus 22 comprises the endstop 21. The apparatus 22 also comprises SMA wire 31 in connection with the endstop 21 and the lens component 15. The SMA wire 31 is configured to move the lens component 15 from the second position to the first position as described above.

The actuation apparatus 22 also comprises another SMA wire 33. The SMA wire 33 is also in connection with the lens component 15, and is also in connection with endstop 23 (not shown in top view). The SMA wire 33 is configured to, on contraction, move the lens component 15 from the first position to the second position. That is, the SMA wire 33 is configured to defocus the illumination source such that the illumination source provides flood illumination. The movement of the lens component 15 from the first position to the second position works in a similar and corresponding to the movement of the lens component from the second position to the first position.

FIGS. 5a to 5c illustrate in further detail the movement of the lens component 15 to the first position. FIG. 5a illustrates the actuation apparatus 22 in which the SMA wires 31, 33 are not tensioned. The actuation apparatus 22 also comprises flexures 29, the flexures 29 being flexible elements and being compliant in specific degrees of freedom. When there is no tension in the SMA wires 31, 33 the flexures 29 do not flex.

At FIG. 5b, the SMA wires 31, 33 are tensioned. This causes the flexures 29 to flex, and causes the lens component 15 to be orientated at a non-zero angle to the orientation of the endstops 21, 23 as explained above.

At FIG. 5c, the SMA wire 31 contracts, thereby moving the lens component 15 into contact with the endstop 21 and into the first position as set out above. The flexures 29 flex to provide a force in a direction to retain the lens component 15 in the first position. While the lens component 15 is in the first position, the SMA wire 33 is cool; that is, it is not heated with an electrical current and therefore is not contracted.

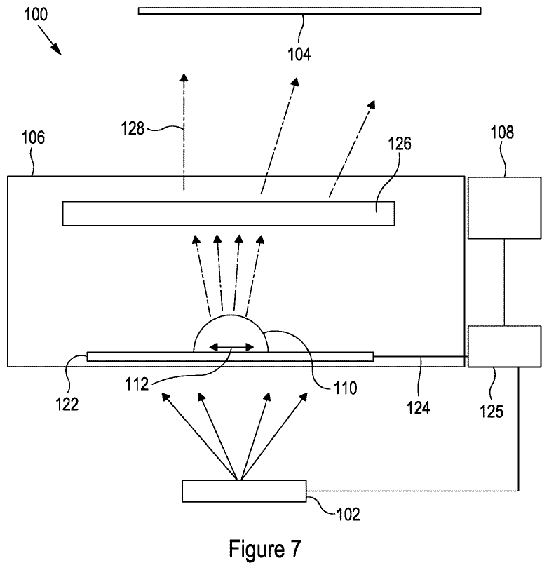

An example time-of-flight sensor system 100 and a method of sensing light scattered from a subject for a time-of-flight sensor system will now be described with reference to FIG. 7. The time-of-flight sensor system is for sensing the time of flight from an illumination source 102 of the system to a subject or three dimensional scene 104.

The time-of-flight sensor system 100 has an illumination source 102; an optical system 106 and a sensor 108. The illumination source 102 is for illuminating the subject 104 to which a time-of-flight is to be measured. In this example, the illumination source 102 is a dot projector formed by a vertical-cavity surface-emitting laser (VCSEL) array, but other appropriate illumination sources may be used. The optical system is located between the illumination source and the subject.

The optical system 106 comprises an optical assembly or element with a lens 110, here a collimating lens, that focusses the illumination source 102, an actuator 122 and a diffraction element in the form of a diffraction grating 126. The lens 110 may comprise a plurality of lenses 100 provided along an optical axis, or it may be a microlens array comprising plural microlens positioned substantially across the same plane along the optical axis.

The lens 110 is movable with respect to the subject 104. For example, the lens can be moved laterally—“side to side”—with respect to the subject along an axis indicated by arrows 112. The lens may also be moved along the other two axes of the three dimensional scene—towards/away from the subject, and vertically or “up and down”—relative to the subject, depending on the use case and the range of motion needed, e.g. switching between spot illumination and flood illumination or adjusting the spot size in spot illumination. The lateral and axial movements may be effected by a single actuator, or by different actuators. This movement may be achieved by sliding the lens along the relevant axis, tilting the lens, or with the use of a steering motor.

The lens 110 interacts with the light source 102 to produce a pattern in the three dimensional scene that matches the pattern of the cavities of the VCSEL array. This pattern provided by the light source 102 is a light pattern of non-uniform intensity, which can be described as spot illumination. In this example, there is a ratio of intensity of illumination at the spots to intensity of illumination between the spots of 30, e.g. in a condition where there is no background illumination or interference. However, the ratio may be, for example, 20 or greater, or 30 or greater in a condition where there is no background illumination or interference.

The actuator 122, in this example, is a shape memory alloy (SMA) actuator comprising one or more SMA components for driving movement in the lens 110. Another type of actuator may be used, such as voice coil motor (VCM) or voice coil actuator, or a microelectromechanical systems (MEMS) magnetic actuator. The actuator 122 engages the lens 110 to move the lens as described above, e.g. substantially along the axis 112. The actuator includes an interface 124 to a processor or controller 125, in particular, a computer controller.

The diffraction element, or the diffraction grating 126 is located between the lens 110 and the subject 104. The diffraction grating diffracts light from the lens and, in particular, collimated light from the lens to provide more spots on the subject. This increases the resolution, which is dependent on the number of spots projected.

Artificial light or illumination 128 from the illumination source 102 forms reflected or scattered light from the subject 104 to the sensor 108 of the time-of-flight sensor system 100. The sensor senses the light scattered by the subject from the illumination source 102.

The system processor or controller 125 is in communication connection with the illumination source 102, the actuator 122 and the sensor 108 to control them, as well as receiving and processing data from them. The controller may be implemented in hardware or in software as a computer program stored in a non-transitory computer-readable medium, which, in this example, is memory of the device on which the time-of-flight sensor system is located, in this example, a smartphone. Although the system controller 125 is shown as a single unit, it may comprise separate modules or units, which are in communication with one another. For example, the system controller 125 may comprise an actuator control unit, a sensor control unit, a light source control unit and an image processor. Alternatively, instead of a single integrated controller comprising each unit, the separate units may be arranged within their respective components. For example, the actuator 122 may itself comprise an actuator controller, the sensor may comprise a sensor controller, the light source may comprise a light source controller. There may also be a separate imager processor.

A scanning pattern of the spot illumination is achieved by the controller 125 controlling the actuator 122 to move the lens 110. The lens 110 directs the illumination source 102 towards the subject 104. The particular positioning of the spot pattern in relation to the subject is controlled by the controller 125 controlling the actuator 122. The controller 125 is able to control the actuator 122 to move the lens 110, which moves the spot pattern relative to the subject.

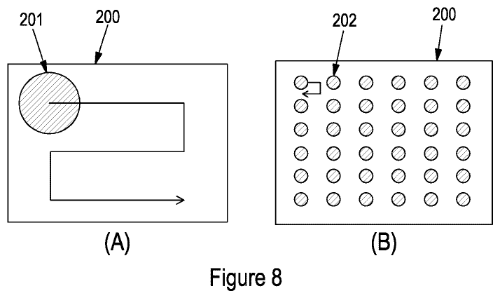

The spot illumination used in this example is illustrated in FIG. 8. In this example, the spot illumination comprises a pattern of dots of light. However, it will be understood that any beam shape may be used, as described above. The spatially non-uniform intensity of the spot illumination corresponds to a set of regions 202 in which the peak emitted intensity is substantially constant. The ratio of intensity of illumination at the dots of light to the intensity of illumination between the dots of light is greater than 30.

As shown in FIG. 8, for a given lens placement, each spot 201 of the spot pattern will illuminate a particular area or plurality of areas of the subject/scene 200. As the actuator 122 moves the lens 110, the spot 201 correspondingly moves across the scene to illuminate a second area of the subject or scene. An example of movement of a single spot is shown in FIG. 8A. In FIG. 8B, a spot pattern is shown comprising a grid of spots in which each spot moves across the subject as the actuator moves the lens. This movement may be described as a scanning pattern as the spot illumination is “scanned” across the subject/field of view. It will be appreciated that a number of different scanning patterns may be used depending on the use case. In the example as shown in FIG. 8, the scanning pattern shown comprises moving the spot illumination in a first direction, a second direction, and a third direction, where the first and third directions are parallel and are perpendicular to the second direction in a movement plane. Broadly speaking, the exemplified scanning pattern as shown in FIG. 8 may be described as a “zig-zag” movement. Movement in the three directions makes up a scanning cycle of the scanning pattern.

The movement depends on the type of actuator used; they have different characteristics. For example, VCMs, for example, have a higher maximum speed, but a characteristic ringing of a longer decaying oscillation around the target position to most quickly decelerate to the target position.

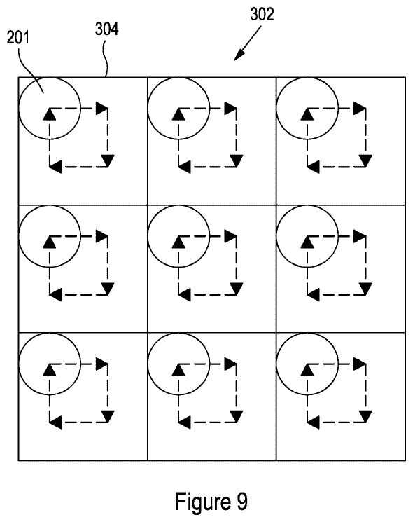

As shown in FIG. 9, each spot 201 that reflects off the subject, and is received by sensor 108, illuminates a corresponding area on the surface 302 of the sensor that detects light—referred to as the sensor surface from here on out. The sensor surface 302 represents that sensor's field of view, and is thus a representation of the scene from the point of view of the sensor 108. Thus, the position of the spot 201 on the sensor surface 302 corresponds to a position of the spot in the scene, or in other words, a position of the spot on the subject 104.

Thus, as the spot pattern is moved relative to the subject 104—by engagement of the actuator 122 on the lens 110—the spot pattern correspondingly moves across the sensor surface 302, as shown by the dashed arrows.

The sensor surface 302 comprises a number of pixels 304—e.g. one or more pixels. In the present embodiment, relatively large pixels are used. In particular, a sensor with approximately 10,000 pixels are used (although other sensors, such as 300,000 pixel sensors, may be used). As discussed previously, larger pixels are superior at collecting incident light compared to smaller pixels. However, fewer pixels used results in lower resolution output frames produced from the sensor.

The time of flight sensor system is configured to provide a spot pattern comprising a grid of spots. The area of each pixel 304 of the sensor surface 302 is larger than the area of the sensor surface illuminated by a spot 201 of the grid of spots. Further, each spot is contained within the bounds of a pixel 304 and the number of spots in the grid of spots corresponds to the number of pixels 304 making up the sensor surface 302. In other words, the grid of spots is aligned with the array of pixels such that each pixel contains a spot, as shown in FIG. 9. More particularly, in the example shown in FIG. 9, the spots are positioned in the top left corner of each pixel. It will be appreciated, however, that other spot patterns are possible.

For example, a spot pattern may comprise a single spot contained within a pixel. Alternatively, the spot pattern may comprise one or more spots in which a number of the spots cross pixel boundaries.

The relative calibration of the light source 102, optical system 106 and sensor 108 to ensure correct placement of the spots one the sensor surface 302—for example, correct alignment of individual spots with a respective pixel—may be performed when the system is assembled, for example, using active alignment or other appropriate method.

When the spot pattern is incident on the sensor surface 302, the data for each pixel 304 is read out by the sensor 108 and provided to the processor 125 for image processing. The data for each pixel 304 provides information on the illumination received by that pixel. As discussed above, if a pixel is not illuminated at all, it can provide no meaningful information about the subject. However, here, each pixel is illuminated by a spot, so every pixel contributes useful information.

The information is used by the processor 125 to form an output frame—in particular, a depth map—that provides time of flight information (e.g. depth information) regarding the subject in the scene. The output frame comprises frame pixels, each frame pixel reflecting the illumination data captured by the corresponding pixel on the sensor surface 302.

Once a first set of data, which reflects the areas of the sensor surface illuminated by the one or more sensed spots of light, has been passed to the processor, the spot pattern is moved relative to the subject such that each of the one or more sensed spots of light illuminates a second respective area of the sensor surface. The distance moved by each of the one or more spots of light is less than a distance spanned by a pixel of the one or more pixels. The distance spanned by a pixel across the sensor surface sometimes referred to as the pixel pitch. In the present embodiment, the spots are moved within their respective pixels. In other words, the actuator 122 precisely adjusts the lens 110 to move each spot 201 across the sensor surface 302 within the bounds of its respective pixel 304. More specifically, the spot pattern is shifted so that each spot moves from a top left corner of their respective pixel to top right hand corner of their respective pixel. Here, the distance moved is smaller than the pixel pitch, but far enough so that the first and second areas illuminated by the pixels do not overlap. As can be seen in FIG. 9, a single spot illuminates an area of its respective pixel that is less than 50% of the total area of the pixel. In the present embodiment, the illuminated area of a pixel by a spot is approximately 25% of the total area of the pixel. In other embodiments, the illuminated area of a pixel by a spot may be approximately 33%, 11.1%, or 6.25%, of the total area of the pixel.

A second set of data, which reflects the second set of areas illuminated by the moved spots, is passed to the processor to produce a second output frame.

This process may be repeated a number of times to produce further output frames. For example, as shown by the dashed arrows of FIG. 9, the process may be repeated for the bottom right corner of each pixel and the bottom left corner of each pixel 201. Again, with each scan, distance moved is smaller than the pixel pitch, but large enough so that the areas illuminated by the pixels before and after the scan do not overlap. As a spot illuminates approximately 25% of its pixel, and the scan pattern moves the spot around the four corners of the pixel, a large proportion, if not all, of the pixel area is illuminated by the scan pattern. In other examples, where a spot illuminates approximately 6.25% of its pixel, the scan pattern may move the spot around in a 4×4 array in a pixel. It will be appreciated that other spot sizes and scan patterns are possible. For example, if a spot illuminates approximately 50% of the pixel, the spot may only be moved to two positions within the pixel to achieve adequate pixel coverage. Similarly, if a spot illuminates approximately 33% of the pixel, the spot may only be moved, in a linearly manner, to three positions within the pixel to achieve adequate pixel coverage. If the spots are smaller relative to the pixel, there may be more scans in the scan cycle to achieve a similar illumination coverage.

In more general terms, the spots of light comprise a set of regions in which the peak emitted intensity is substantially constant and/or in which the peak emitted intensity is at least 50% of a maximum intensity level. The set of regions together may cover between 1% and 50% of the sensor surface at a given instant of time, depending on the size of a spot relative to the sensor surface, and relative to its corresponding pixel. For example, the set of regions together may cover more than 10% and less than 50% or less than 40% or less than 30% or less than 20% of the sensor surface at a given instant of time, or the set of regions together cover more than 20% and less than 50% or less than 40% or less than 30% of the sensor surface at a given instant of time, or the set of regions together cover more than 30% and less than 50% or less than 40% of the sensor surface at a given instant of time, and optionally wherein the set of regions together cover more than 40% and less than 50% of the sensor surface at a given instant of time. Further, the set of regions are arranged such that the movement of the spot illumination causes the set of regions to cover more than 75% or more than 90% or substantially all of the sensor surface during a cycle of a scanning pattern, i.e. as the spots are moved relative to, or within, their respective pixels.

The controller 125 may determine where a spot is within a given pixel across each scan cycle (i.e. provide a spot pattern on the sensor surface, provide sensed data, and move pattern to a new position) by appropriate calibration techniques. For example, during a start-up phase, the system may go through a process in which a zero position is determined which corresponds to the spots being in certain places on certain pixels. For example, considering a single pixel and a single spot, the actuator may move the spot to the left/right, and observe and determine the position at which the spot is no longer on the pixel. This would give the actuator position required for the spot to be on the left/right hand edge of the pixel. This can be repeated for the up/down direction. Once a known position is found then the actuator control can define the position of the spot on the pixel. I.e. it can be determined that by moving the actuator 10 um (for example) the spot (or spots) move over half a pixel width.

Once a number of output frames have been produced—here, four frames—the processor combines these frames to provide a final, super-resolution (high resolution), frame. This is shown in FIG. 10. Here, the resolution of the super-resolution frame is equal to the sum of the resolutions of the each combined output frame. Effectively, this produces a final image with resolution that would ordinarily have been produced by a sensor having four times as many pixels as was used by the present invention.

The processor determines how to combine the output frames from the data received from the actuator and the sensor. For example, the initial spot position, along with the spot spacing and the distances the spots move across the scan cycle, as determined by the system, may be communicated to the processor. The processor then uses this information to build the super resolution frame. This information may be captured each time a frame is generated and passed to the processor as meta data alongside the pixel information. Alternatively, in some arrangements, some or all of this information may not be necessary for the processor to build the super resolution frame. For example, algorithms may be employed to combine the frames without prior knowledge on spot position.

As shown in FIG. 10, and discussed above, four frames have been generated. The first frame represents pixel data reflecting the spot pattern of sensed spots in the top left of their respective pixels of the sensor. This produces a frame having frame pixels labelled as “A” frame pixels in FIG. 10. The second frame represents pixels reflecting the spot pattern of spots in the top right of their respective pixels. This produces a frame having frame pixels labelled as “B” frame pixels in FIG. 10. The third frame represents the pixels reflecting the spot pattern of spots in the bottom left of their respective pixels. This produces a frame having frame pixels labelled as “C” frame pixels in FIG. 10. The fourth frame represents pixels reflecting the spot pattern of spots in the bottom right of their respective pixels. This produces a frame having frame pixels labelled as “D” frame pixels in FIG. 10. The pixel data of each of the four frames are correspondingly combined in the super resolution frame such that each frame pixel for the top left spot pattern is arranged in the final frame relative to a corresponding frame pixel for the top right, bottom left and bottom right spot patterns. In other words, each A pixel in the super resolution frame will have the corresponding B pixel to its right, a corresponding C pixel directly below it, and a corresponding D pixel below and to the right of it.

The super resolution frame provides a high resolution depth map for TOF calculations. By combining the output frames, the resolution is increased fourfold without having to decrease pixel size. Further, by providing sub-pixel size spots, and moving the spots within the bounds of their respective pixels during scanning, every pixel of the sensor face is contributing useful pixel data during frame generation. This improves efficiency.

Embodiments of the present invention have been described. It will be appreciated that variations and modifications may be made to the described embodiments within the scope of the present invention. For example, the example time-of-flight sensor system is described as located in a smartphone, however, the time-of-flight sensor system may be located in a computer, such as a laptop computer, tablet computer or desktop computer, in a vehicle, or other consumer device.

Further, although the actuator has been described as moving the spot illumination by engaging with a collimation lens, it will be appreciated that a different lens may be used. Alternatively, or in addition, the actuator may engage directly with light source to move the spot illumination, or may engage with the diffraction element/grating, or may move the lens and the diffraction element/grating together relative to the light source to move the spot illumination relative to the subject. In other arrangements, a diffraction element grating may not be used at all.

Embodiments of the present invention have been described. It will be appreciated that variations and modifications may be made to the described embodiments within the scope of the present invention. For example, the example time-of-flight sensor system is described as located in a smartphone device, however, the time-of-flight sensor system may be located in a computer, such as a laptop computer, tablet computer, or desktop computer, in a vehicle, or other consumer device.

1. A time-of-flight sensor system comprising:
an illumination source for illuminating a subject to which a time-of-flight is to be measured;
an optical system configured to transition the illumination source between providing spot illumination and flood illumination; and
a sensor comprising a sensor surface, the sensor being configured to sense light scattered by the subject from the illumination source and to provide data dependent on sensed light, wherein
the spot illumination has a spatially non-uniform intensity over the sensor surface, and the optical system is configured to, using an at least one actuator, move the spot illumination across at least part of the sensor surface to generate an output frame, wherein the at least one actuator comprises at least one shape memory alloy (SMA) component.

2. The time-of-flight sensor system according to claim 1, wherein the optical system is configured to move the spot illumination in a scanning pattern across at least part of the sensor surface.

3. The time-of-flight sensor system according to claim 2, wherein the scanning pattern comprises moving the spot illumination along a first direction across at least part of the sensor surface,
wherein the scanning pattern further comprises moving the spot illumination along a second direction across at least part of the sensor surface, and
wherein the first direction is perpendicular to the second direction or angled to the second direction in a plane.

4-7. (canceled)

8. The time-of-flight sensor system according to claim 2, wherein the optical system is configured to focus and defocus the illumination source using the at least one actuator.

9. The time-of-flight sensor system according to claim 8, wherein the optical system is configured to focus and defocus the illumination source by moving, relative to a support structure, a moveable element between a respective first position and second position,
wherein the at least one SMA component is connected between the moveable element and the support structure, the SMA component being configured to, on contraction, move the moveable element from the first position to the second position, and
wherein the at least one actuator comprises a second SMA component connected between the moveable element and the support structure, the second SMA component configured to, on contraction, move the moveable element from the second position to the first position.

10-15. (canceled)

16. The time-of-flight sensor system according to claim 9, wherein the moveable element is configured to move along a movement axis and is prevented from moving beyond the first position or the second position by support portions of the support structure, and
wherein the moveable element is orientated at a non-zero angle to the orientation of the support portions such that when the moveable element moves towards the first position or the second position, a first portion of the moveable element contacts the support portion before a second portion of the moveable element, causing the moveable element to be tilted about a rotation axis.

17-21. (canceled)

22. The time-of-flight sensor system according to claim 9, wherein the moveable element is a lens component.

23-31. (canceled)

32. The time-of-flight sensor system according to claim 1, wherein the optical system is configured to determine, for the illumination source, which of spot illumination or flood illumination to provide, based on one or more of a desired range of illumination, a desired resolution of the generated image, or a desired frame rate, and/or
wherein the optical system determines which of spot illumination or flood illumination to provide based on a mode of operation of the time-of-flight sensor system.

33-35. (canceled)

36. The time-of-flight sensor system according to claim 1, wherein the spot illumination comprises one or more spots, and a ratio of intensity of illumination at the one or more spots to intensity of illumination between the one or more spots is 20 or greater, such as 30 or greater, and/or
wherein the flood illumination comprises a ratio of intensity of illumination at spots of the flood illumination to intensity of illumination between the spots of the flood illumination of 2 or less, such as 1.5 or less.

37. (canceled)

38. The time-of-flight sensor system according to claim 1, wherein the optical system is configured to move the spot illumination in a continuous manner during which the sensor senses the scattered light, or
wherein the optical system is configured to pause movement of the spot illumination at plural predetermined positions along a path of movement so as to allow the sensor to sense the scattered light at the predetermined positions, and to resume movement along the path of movement once the sensor has finished sensing the scattered light.

39-46. (canceled)

47. A method of sensing light scattered from a subject for a time-of-flight sensor system, the method comprising:
determining, for an illumination source, which of flood illumination or spot illumination to provide;
illuminating, by the illumination source, the subject with the determined flood illumination or spot illumination; and
sensing, by a sensor, light scattered by the subject from the illumination source and providing data dependent on the sensed light, the sensor comprising a sensor surface, wherein
the spot illumination has a spatially non-uniform intensity over the sensor surface, and when the illumination source provides spot illumination, moving the spot illumination across at least part of the sensor surface to generate an output frame.

48. The method according to claim 47, further comprising:
pausing movement of the spot illumination at plural predetermined positions along a path of movement;
sensing the scattered light at the predetermined positions, and
resuming movement along the path of movement once the sensor has finished sensing the scattered light.

49-58. (canceled)

59. A time-of-flight sensor system comprising:
an illumination source configured to illuminate a subject to which a time-of-flight is to be measured, wherein the illumination is spot illumination comprising one or more spots of light;
a sensor comprising a sensor surface having one or more pixels, the sensor being configured to:
sense one or more spots of light, scattered by the subject from the illumination source, that each illuminates a respective first area of the sensor surface, wherein each pixel of the one or more pixels has an area larger than the first area of the sensor surface illuminated by a sensed spot of light, and
provide a data set dependent on the one or more sensed spots of light, the provided data set being for generation of an output frame reflecting each area of the sensor surface illuminated by the one or more sensed spots of light; and
an optical system configured, relative to the illumination source and using an at least one actuator, to move the spot illumination relative to the subject such that each of the one or more sensed spots of light moves to illuminate a respective second area of the sensor surface, the distance moved by each of the one or more spots of light being less than a distance spanned by a pixel of the one or more pixels, wherein the at least one actuator comprises at least one shape memory alloy (SMA) component.

60. The time-of-flight sensor system according to claim 59, wherein the time-of-flight sensor system is configured to use the data set to generate an output frame reflecting each first area of the sensor surface illuminated by the one or more sensed spots of light.

61. The time-of-flight sensor system according to claim 60, wherein the sensor is configured to, each time the optical system engages the illumination source to move the spot illumination relative to the subject, provide a second data set dependent on the moved one or more sensed spots of light,
wherein the time-of-flight sensor system is configured to generate a second output frame using each second data set, each second output frame reflecting the second areas of the sensor surface illuminated by the respective moved one or more sensed spots of light,
wherein the time-of-flight sensor system is configured to combine two or more output frames to produce a final output frame, and
wherein the final output frame has a resolution equal to the sum of the resolutions of the or each combined output frame.

62-64. (canceled)

65. The time-of-flight sensor system according to claim 59, wherein each respective area of the sensor surface illuminated by a sensed spot of light equal to the respective first area of the sensor surface and is within the bounds of a corresponding pixel of the one or more pixels,
wherein the optical system is configured to engage the illumination source to move the spot illumination relative to the subject such that each respective second area illuminated by a moved spot of light remains within the bounds of the corresponding pixel, and
wherein corresponding first and second areas do not overlap.

66-70. (canceled)

71. The time-of-flight sensor system according to claim 59, wherein the one or more pixels comprises an array of pixels and the distance spanned by a pixel comprises the pixel pitch for the pixels of the array, wherein the one or more sensed spots of light comprises a spot pattern made up of a grid of spots of light that corresponds to the array of pixels such that each sensed spot of light illuminates an area of the sensor surface that is within the bounds of a respective pixel in the array.

72. The time-of-flight sensor system according to claim 59, wherein the optical system is configured to move the spot illumination in a scanning pattern across at least part of the sensor surface.

73. The time-of-flight sensor system according to claim 72 wherein, the scanning pattern comprises moving the spot illumination along a first direction across at least part of the sensor surface,
wherein the scanning pattern further comprises moving the spot illumination along a second direction across at least part of the sensor surface, and
wherein the first direction is perpendicular to the second direction or angled to the second direction in a plane.

74-75. (canceled)

76. The time-of-flight sensor system according to claim 59, wherein the optical system comprises a diffraction element for providing one or more spots of light,
wherein the optical system comprises a lens for focusing the one or more spots of light onto the subject, and
wherein the optical system is configured to move the spot illumination relative to the source by the actuator engaging the lens to move the lens relative to the illumination source to move the spot illumination relative to the subject.

77-91. (canceled)
